(19) United States
(12) Patent Application Publication
(10) Pub. No.: US 2026/0187098 A1
(43) Pub. Date: Jul. 2, 2026

(54) ARTIFICIAL INTELLIGENCE-BASED GENERATION OF INTERMEDIATE ADAPTER FOR INTEGRATING DISPARATE DATA SOURCES

(71) Applicant: BANK OF AMERICA CORPORATION, Charlotte, NC (US)

(72) Inventors: Manu Kurian, Dallas, TX (US); Aryan Roy, Charlotte, NC (US); Aeric John Solow, Allen, TX (US)

(73) Assignee: BANK OF AMERICA CORPORATION, Charlotte, NC (US)

(21) Appl. No.: 19/007,642

(22) Filed: Jan. 2, 2025

(51) Int. Cl. G06F 16/25

(52) U.S. Cl. CPC G06F 16/258; G06F 16/254

(57) ABSTRACT

Artificial Intelligence (AI) in implemented to integrate disparate data sources. Machine Learning (ML) is trained and subsequently implemented to analyze disparate data sources to determine differences/gaps between the data sources and subsequently Generative Artificial Intelligence (GenAI) is used to generate an integration adapter that is data source-specific, acts as an intermediary for integrating (e.g., connecting or converting) the data sources and serves to address the determined differences/gaps between the data sources.

### FIELD OF THE INVENTION

The present invention is generally directed to digital data source management and, more specifically, implementing Artificial Intelligence (AI) in the form of Machine Learning (ML) and Generative AI to analyze two disparate data sources to determine differences between the data sources and subsequently generate a data source-specific integration adapter that acts as an intermediary for integrating (e.g., connecting or converting) the data sources.

### BACKGROUND

Data sources refer to origins from which data is collected, stored and processed. While databases are typically viewed as synonymous with data sources, data sources are not limited to databases and include data repositories, data warehouses, data lakes and the like. The different types of data sources may vary based on purpose, structure and functionality. For example, different data sources may vary in the type of data stored therein (e.g., structured, semi-structured, and unstructured), how data is formatted (e.g., defined schemas) and defined-application use versus analytical or archival use.

Often times users may desire to integrate one data source with another data source. Such data integration includes connecting one data source to another data source and converting one data source to another data source. Such data integration is typically problematic, in that, manual intervention is needed because each data source is unique and thus each data integration is unique. Data integration requires identifying the differences/gaps between the two data sources and addressing these differences/gaps in the integration process. Such differences gaps include missing data, fields, different or missing schemas or the like, as well as differences in how the data is accessed, controlled and used. Moreover, data integration tends to be inefficient and, since the data sources may be inaccessible during such integration, applications that rely of the data sources may be impacted during integration periods.

Therefore, a need exists to develop systems, computer-implemented methods, computer program products or the like that improve upon how data integration occurs between disparate data sources. In this regard, the desired systems, computer-implemented method should provide improvement as to how disparate data sources are connected or converted. Moreover, the desired systems, computer-implemented method should take into account the uniqueness associated with every data source integration.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by implementing Artificial Intelligence (AI) to integrate disparate data sources. Specifically, Machine Learning (ML) is used to analyze disparate data sources to determine differences between the data sources and subsequently Generative Artificial Intelligence (GenAI) is used to generate an integration adapter that is data source-specific and acts as an intermediary for integrating (e.g., connecting or converting) the data sources. The data sources may take the form of databases, data repositories, data warehouses, data lakes and the like. In specific embodiments the data sources that are integrated may be the same in form (e.g., database-to-database or data lake-to-data lake integration), while in other embodiments of the invention the data sources integrated may be different in form (e.g., database-to-data repository or data repository-to-data warehouse integration).

The ML model(s) are trained to scan the data sources to assess/determine data source features, including, but not limited to, (i) data, (ii) data source type, (iii) version, (iv) encoding, (v) storage mechanisms, (vi) one or more schemas, (vii) data relationships, (viii) data size, and (ix) data complexity. In response to assessment, the ML models are trained to compare the results of the assessment to determine the differences or gaps between the two disparate data sources.

The GenAI model(s) are trained to generate a unique integration adapter data that is specific to first and second data source and is based at least on model inputs including the outputs of the ML model(s) (e.g., the assessment of the data sources, and the identified differences between the first and second data sources). The integration adapter, which is configured to integrate the disparate data sources, comprises executable-code that addresses the identified differences between the first and second data sources. In response to generating the data source-specific integration adapter, the data integration engine is executed to integrate the disparate data sources.

In specific instances the integration adapter is a connection adapter configured to connect the two disparate data sources. In such instances, the connection adapter may include other connection logic, such as (i) data format compatibility logic configured to align structured formats and schemas and parse unstructured data, (ii) Application Programming Adapter (API) and protocol compatibility logic configured to assure API and protocol compatibility between the first and second data sources, (iii) schema compatibility logic configured to align schemas from the first data source and the second data source and, in stances where alignment is not feasible, map and transform schemas, (iv) authentication and authorization logic configured to exchange at least one of authentication credentials and authorization credentials between the first and second data sources and (v) data synchronization logic configured to assure real-time or batch synchronization mechanisms are equivalent. The aforementioned logic may address the differences/gaps in the data sources along with performing ancillary connection processes or the connection adapter may include other features to address the differences/gaps.

In other specific instances the integration adapter is a conversion adapter configured to convert one data source to another data source. In such instances, the conversion adapter may include other conversion logic, such as (i) schema mapping logic configured to perform data field matching, schema normalization, relationship conversion, (ii) data transformation logic configured to extract the data from the first data source, transform the data (including addressing null and predefined fallback values and removing duplicate data) to match a schema of the second data source and load the transformed data into the second data source, (iii) connectivity logic configured to install requisite drivers and generate Application Programming Adapters (APIs) and (iv) data migration logic configured to orchestrate the migration of data from the first data source to the second data source. The aforementioned logic may address the differences/gaps in the data sources along with performing ancillary conversion processes or the conversion adapter may include other features to address the differences/gaps.

A system for data integration between two disparate data sources defines first embodiments of the invention. The system includes a first data source configured to store first data and a second data source configured to store second data. The second data source is disparate from the first data source. In this regard the first and second data sources may be disparate in terms of data source type, data formats, data source schemas, technology stacks or the like. In specific embodiments of the system, the first and second data sources may take the form of any one of a database, a data repository, a data warehouse, and a data lake.

The system additionally includes a computing platform having a memory and one or more computing processor devices in communication with the memory. The memory stores a data integration engine, which is executable by at least one of the computing processor device(s) and includes one or more Machine Learning (ML) models and one or more Generative Artificial Intelligence (GenAI) models. The data integration engine and configured to implement at least one of the one or more ML models, to scan the first and second data sources to (i) assess the first and second data sources, and (ii) identify differences (i.e., gaps, missing components or the like) between the first and second data sources. In specific embodiments of the system, assessing the data sources includes, but is not limited to, determining/identifying (i) data source type, (ii) version, (iii) encoding, (iv) storage mechanisms, (v) one or more schemas, (vi) data relationships, (vii) data size, and (viii) data complexity.

In response to the scanning of the data sources, data integration engine is further configured to implement at least one of the one or more GenAI models to generate a data source-specific (i.e., specific to first and second data sources) integration adapter based at least on (i) assessment of the first and second data sources, and (ii) identified differences between the first and second data sources. The integration adapter is configured to integrate the first and second data sources by generating executable-code that addresses the identified differences between the first and second data sources. In response to generating the data source-specific integration adapter, the data integration engine is further configured to execute the integration adapter to integrate the first data source and the second data source.

In specific embodiments of the system, the data source-specific integration adapter is a data source conversion adapter configured to convert the first data source to the second data source. In related embodiments of the system, the data source-specific conversation adapter includes at least one of (i) schema mapping logic configured to perform data field matching, schema normalization, relationship conversion, (ii) data transformation logic configured to extract the data from the first data source, transform the data (including addressing null and predefined fallback values and removing duplicate data) to match a schema of the second data source and load the transformed data into the second data source, (iii) connectivity logic configured to install requisite drivers and generate Application Programming Adapters (APIs) and (iv) data migration logic configured to orchestrate the migration of data from the first data source to the second data source.

In other specific embodiments of the system, the data source-specific integration adapter is a data source connection adapter configured to connect the first data source to the second data source. In related embodiments of the system, the data source-specific conversation adapter includes at least one of (i) data format compatibility logic configured to align structured formats and schemas and parse unstructured data, (ii) Application Programming Adapter (API) and protocol compatibility logic configured to assure API and protocol compatibility between the first and second data sources, (iii) schema compatibility logic configured to align schemas from the first data source and the second data source and, in stances where alignment is not feasible, map and transform schemas, (iv) authentication and authorization logic configured to exchange at least one of authentication credentials and authorization credentials between the first and second data sources, and (v) data synchronization logic configured to assure real-time or batch synchronization mechanisms are equivalent.

A computer-implemented method for data integration between two disparate data sources defines second embodiments of the invention. The computer-implemented is method executed by one or more computing processor devices. The computer-implemented method includes implementing at least one Machine learning (ML) model, to scan a first data source and a second data source to (i) assess the first and second data sources, and (ii) identify differences between the first and second data sources. In specific embodiments of the system, assessing the data sources includes, but is not limited to, determining/identifying (i) data source type, (ii) version, (iii) encoding, (iv) storage mechanisms, (v) one or more schemas, (vi) data relationships, (vii) data size, and (viii) data complexity.

The computer-implemented method additionally includes implementing at least one Generative Artificial Intelligence (GenAI) model to generate a data source-specific integration adapter based at least on (i) assessment of the first and second data sources, (ii) identified differences between the first and second data sources. The integration adapter is configured to integrate the first and second data sources by generating executable-code that addresses the identified differences between the first and second data sources. In response to generating the data source-specific integration adapter, the computer-implemented method includes executing the integration adapter to integrate the first data source and the second data source.

In specific embodiments of the computer-implemented method, implementing the at least one GenAI model further includes implementing the at least one GenAI model to generate the data source-specific integration adapter, which is a data source conversion adapter configured to convert the first data source to the second data source. In such embodiments of the computer-implemented method, the data source conversion adapter and includes one or more of (i) schema mapping logic configured to perform data field matching, schema normalization, relationship conversion, (ii) data transformation logic configured to extract the data from the first data source, transform the data to match a schema of the second data source and load the transformed data into the second data source, wherein transforming the data includes addressing null and predefined fallback values and removing duplicate data, (iii) connectivity logic configured to install requisite drivers and generate Application Programming Adapters (APIs) and (iv) data migration logic configured to orchestrate the migration of data from the first data source to the second data source.

In other specific embodiments of the computer-implemented method, implementing the at least one GenAI model further includes implementing the at least one GenAI model to generate the data source-specific integration adapter, which is a data source connection adapter configured to connect the first data source to the second data source. In such embodiments of the computer-implemented method, the data source connection adapter includes one or more of (i) data format compatibility logic configured to align structured formats and schemas and parse unstructured data, (ii) Application Programming Adapter (API) and protocol compatibility logic configured to assure API and protocol compatibility between the first and second data sources, (iii) schema compatibility logic configured to align schemas from the first data source and the second data source and, in stances where alignment is not feasible, map and transform schemas, (iv) authentication and authorization logic configured to exchange at least one of authentication credentials and authorization credentials between the first and second data sources and (v) data synchronization logic configured to assure real-time or batch synchronization mechanisms are equivalent.

A computer program product including a non-transitory computer-readable medium defines third embodiments of the invention. The non-transitory computer-readable medium includes sets of codes for causing one or more computing devices to implement at least one Machine learning (ML) model, to scan a first data source and a second data source to (i) assess the first and second data sources, and (ii) identify differences between the first and second data sources. The sets of codes additionally cause the computing device(s) to implement at least one Generative Artificial Intelligence (GenAI) model to generate an integration adapter that is data source-specific (i.e., specific to the pair of data sources) and is based at least on (i) assessment of the first and second data sources, (ii) identified differences between the first and second data sources. The integration adapter is configured to integrate the first and second data sources by generating executable-code that addresses the identified differences between the first and second data sources. Further, the sets of codes cause the computing device(s) to execute the integration adapter to integrate the first data source and the second data source.

In specific embodiments of the computer program product, the set of codes for causing the one or more computing devices to implement the at least GenAI models are further configured to cause the one or more computing devices to implement the at least one GenAI model to generate the integration adapter, which is either a data source connection adapter or a data source conversion adapter.

Thus, as described in detail below, present embodiments of the invention provide for implementing Artificial Intelligence (AI) to integrate disparate data sources. Specifically, Machine Learning (ML) is used to analyze disparate data sources to determine differences between the data sources and subsequently Generative Artificial Intelligence (GenAI) is used to generate an integration adapter that is data source-specific, acts as an intermediary for integrating (e.g., connecting or converting) the data sources and serves to address the determined differences/gaps between the data sources.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block of a system for data source integration, in accordance with embodiments of the present invention;

FIG. 2 is a block diagram of a computing platform storing a data integration engine, in accordance with embodiments of present invention;

FIG. 3 is a schematic/block diagram of a data integration adapter in the form of a data source connection adapter, in accordance with embodiments of the present invention;

FIG. 4 is a schematic/block diagram of a data integration adapter in the form of a data source conversion adapter, in accordance with embodiments of the present invention;

FIG. 5 is a schematic/block of a system for enhancing programming functionality in a data source, in accordance with embodiments of the present invention;

FIG. 6 is a block diagram of a computing platform storing a data source programming functionality enhancement engine, in accordance with embodiments of present invention;

FIG. 7 is a flow diagram of a method for data source integration, in accordance with embodiments of present invention;

FIG. 8 is a flow diagram of a method for enhancing data source programming functionality;

FIG. 9 is a schematic/flow diagram of a system for Machine Learning (ML)model generation and training, in accordance with embodiments of the present invention; and

FIG. 10 is a block diagram of a system for Generative Artificial Intelligence (Gen AI) generation and training, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product, or a combination of the foregoing. Accordingly, embodiments of the present invention may take the form of an entirely hardware embodiment, an entirely software embodiment (including firmware, resident software, micro-code, a.), or an embodiment combining software and hardware aspects that may be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for conducting operations of embodiments of the present invention may be written in an object oriented, scripted, or unscripted programming language such as JAVA, PERL, SMALLTALK, C++, PYTHON, or the like. However, the computer program code/computer-readable instructions for conducting operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to conduct an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

“Computing platform” or “computing device” as used herein refers to a networked computing device within the computing system. The computing platform includes a processor, a non-transitory storage medium (i.e., memory), a communications device, and a display. The computing platform may be configured to support user logins and inputs from any combination of similar or disparate devices. Accordingly, the computing platform includes servers, personal desktop computer, laptop computers, mobile computing devices and the like.

Thus, systems, apparatus, and methods are described in detail below that implement Artificial Intelligence (AI) to integrate disparate data sources. Specifically, Machine Learning (ML) is used to analyze disparate data sources to determine differences between the data sources and subsequently Generative Artificial Intelligence (GenAI) is used to generate an integration adapter that is data source-specific and acts as an intermediary for integrating (e.g., connecting or converting) the data sources. The data sources may take the form of databases, data repositories, data warehouses, data lakes and the like. In specific embodiments the data sources that are integrated may be the same in form (e.g., database-to-database or data lake-to-data lake integration), while in other embodiments of the invention the data sources integrated may be different in form (e.g., database-to-data repository or data repository-to-data warehouse integration).

The ML model(s) are trained to scan the data sources to assess/determine data source features, including, but not limited to, (i) data, (ii) data source type, (iii) version, (iv) encoding, (v) storage mechanisms, (vi) one or more schemas, (vii) data relationships, (viii) data size, and (ix) data complexity. In response to assessment, the ML models are trained to compare the results of the assessment to determine the differences or gaps between the two disparate data sources.

The GenAI model(s) are trained to generate a unique integration adapter data that is specific to first and second data source and is based at least on model inputs including the outputs of the ML model(s) (e.g., the assessment of the data sources, and the identified differences between the first and second data sources). The integration adapter, which is configured to integrate the disparate data sources, comprises executable-code that addresses the identified differences between the first and second data sources. In response to generating the data source-specific integration adapter, the data integration engine is executed to integrate the disparate data sources.

In specific instances the integration adapter is a connection adapter configured to connect the two disparate data sources. In such instances, the connection adapter may include other connection logic, such as (i) data format compatibility logic configured to align structured formats and schemas and parse unstructured data, (ii) Application Programming Adapter (API) and protocol compatibility logic configured to assure API and protocol compatibility between the first and second data sources, (iii) schema compatibility logic configured to align schemas from the first data source and the second data source and, in stances where alignment is not feasible, map and transform schemas, (iv) authentication and authorization logic configured to exchange at least one of authentication credentials and authorization credentials between the first and second data sources and (v) data synchronization logic configured to assure real-time or batch synchronization mechanisms are equivalent. The aforementioned logic may address the differences/gaps in the data sources along with performing ancillary connection processes or the connection adapter may include other features to address the differences/gaps.

In other specific instances the integration adapter is a conversion adapter configured to convert one data source to another data source. In such instances, the conversion adapter may include other conversion logic, such as (i) schema mapping logic configured to perform data field matching, schema normalization, relationship conversion, (ii) data transformation logic configured to extract the data from the first data source, transform the data (including addressing null and predefined fallback values and removing duplicate data) to match a schema of the second data source and load the transformed data into the second data source, (iii) connectivity logic configured to install requisite drivers and generate Application Programming Adapters (APIs) and (iv) data migration logic configured to orchestrate the migration of data from the first data source to the second data source. The aforementioned logic may address the differences/gaps in the data sources along with performing ancillary conversion processes or the conversion adapter may include other features to address the differences/gaps.

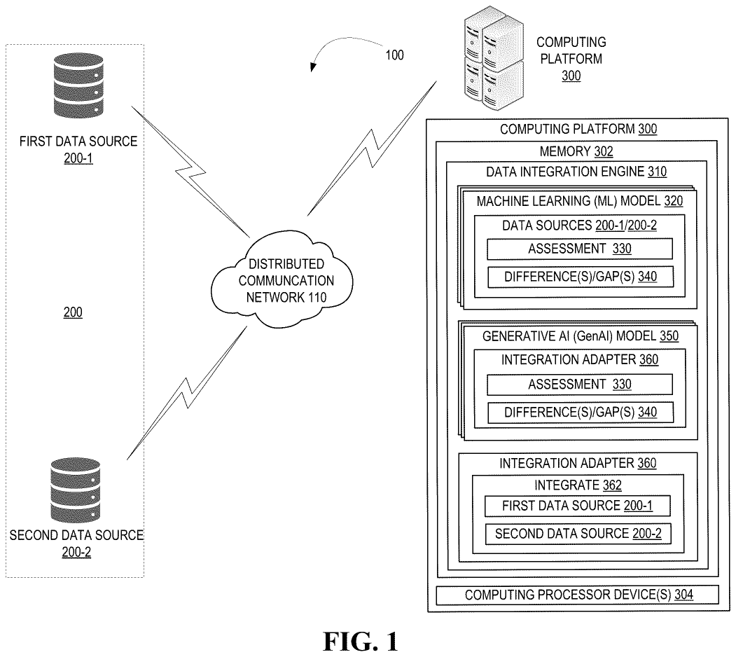

Referring to FIG. 1, a schematic/block is presented of a system 100 for data source integration, in accordance with embodiments of the present invention. The system 100 is implemented amongst a distributed communication network 110, which may include the Internet, one or more intranets, cellular network(s) or the like. The system 100 includes two data sources 200; herein first data source 200-1 and second data source 200-1 that require integration. The data sources may take the form of databases, data repositories, data warehouses, data lakes and the like. In specific embodiments the data sources that are integrated may be the same in form (e.g., database-to-database or data lake-to-data lake integration), while in other embodiments of the invention the data sources integrated may be different in form (e.g., database-to-data repository or data repository-to-data warehouse integration).

System 100 additionally includes computing platform 300, which may comprise one or more servers or any other suitable computing device(s). Computing platform 300 includes memory 302 and one or more computing processor devices 304 in communication with memory 302. Memory 302 of computing platform 300 stores data integration engine 310, which includes Artificial Intelligence (AI), specifically one or more Machine Learning (ML) models 320 and Generative AI (GenAI) models 350. Data integration engine 310 is executable by at least one of the computing processor device(s) 304.

Data integration engine 310 is configured to implement at least one of the machine learning (ML) model(s) 320 which have been trained to scan the first data source 200-1 and the second data source 200-2 and perform an assessment 330 of the first and second data sources 200-1, 200-2 and identify one or more differences 340 (i.e., gaps) that exist between the first and second data sources 200-1, 200-2. In specific embodiment the assessment 330 serves to identify the difference(s)/gap(s) 340.

In response to identifying the differences 340, data integration engine 310 is further configured to implement at least one the GenAI model(s) 350 to generate an integration adapter 360 that is data source-specific and based at least on (i) assessment 330 of the first and second data sources 200-1, 200-2, and (ii) identified differences 340 between the first and second data sources 200-1, 200-2. The integration adapter 360 is configured to integrate the first and second data sources 200-1, 200-2 by generating executable-code that addresses the identified differences between the first and second data sources 200-1, 200-2. In response to generating the integration adapter 360, data integration engine 300 is configured to execute the integration adapter 360 to integrate 362 the first and second data sources 200-1, 200-2.

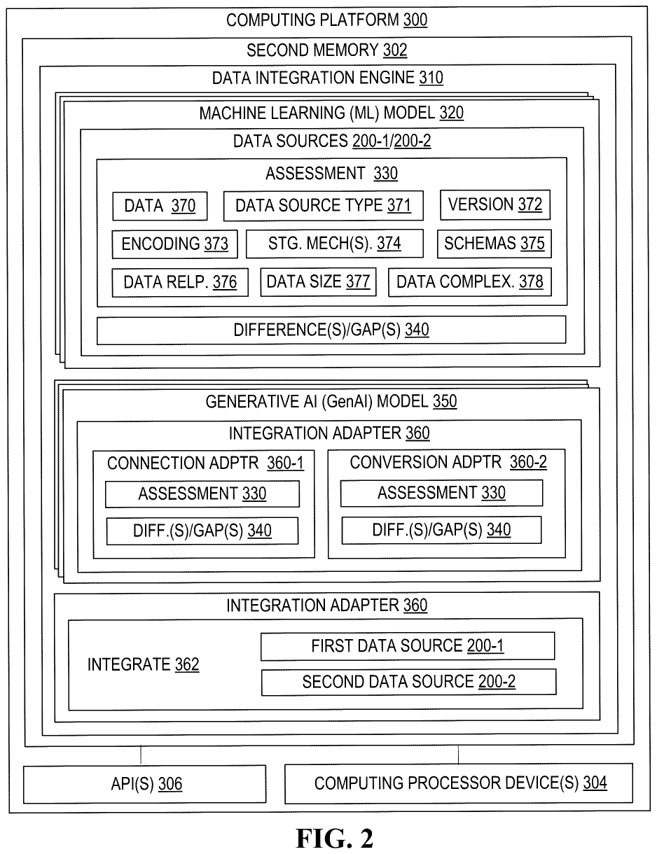

Referring to FIG. 2, a block diagram is depicted of computing platform 300 highlighting various alternate embodiments of the system 100 shown and described in relation to FIG. 1, in accordance with embodiments of the present invention. Computing platform 300 may comprise one or multiple computing devices, such servers or the like. As previously discussed in relation to FIG. 1, computing platform 300 includes memory 302, which may comprise volatile and/or non-volatile memory, such as read-only memory (ROM) and/or random-access memory (RAM), EPROM, EEPROM, or any memory common to computing platforms. Moreover, memory 302 may comprise cloud storage, such as provided by a cloud storage service and/or a cloud connection service.

Further, computing platform 300 includes one or more computing processor devices 304, which may be an application-specific integrated circuit (“ASIC”), or other chipset, logic circuit, or other data processing device. Computing processor device(s) 304 may execute one or more application programming adapter (APIs) 306 that adapter with any resident programs, such as data integration engine 310 or the like, stored in memory 302 of computing platform 300 and any external programs. Computing platform 300 includes various processing sub-systems (not shown in FIG. 2) embodied in hardware, firmware, software, and combinations thereof, that enable the functionality of computing platform 300 and the operability of computing platform 300 on a distributed communication network 110 (shown in FIG. 1). For example, processing sub-systems allow for initiating and maintaining communications and exchanging data with other networked devices. For the disclosed aspects, processing sub-systems of computing platform 300 includes any processing sub-system portion used in conjunction with data integration engine 310, tools, routines, sub-routines, applications, sub-applications, sub-modules thereof.

In specific embodiments of the present invention, computing platform 300 additionally includes a communications module (not shown in FIG. 2) embodied in hardware, firmware, software, and combinations thereof, that enables electronic communications between components of computing platform 300 and other networks and network devices, such first and second data sources 200-1, 200-2. Thus, communication module includes the requisite hardware, firmware, software and/or combinations thereof for establishing and maintaining a network communication connection with one or more devices and/or networks.

As previously discussed in relation to FIG. 1, memory 202 stores data integration engine 310, which is executable by at least one of the computing processor device(s) 304. Data record integration engine 310 includes Artificial Intelligence (AI), which includes, but is not limited to Machine Learning model(s) 320 and Generative AI (GenAI) model(s) 350.

Data integration engine 310 is configured to implement one or more of the ML model(s) 320 to access and scan the first and second data sources 200-1, 200-2 perform an assessment 330 of the first and second data sources 200-1, 200-2 and identify one or more differences 340 (i.e., gaps) that exist between the first and second data sources 200-1, 200-2. In specific embodiments of the system 100, assessment 330 includes, but is not limited to, at least one of assessing the data 370; the data source type 371 (e.g., database, data repository, data ware house, data lake or the like); data source version 372; encoding 373 used within the data source; storage mechanisms 374 (e.g., SQL, NoSQL, relational, object-oriented, cloud, file systems, in-memory, stream, hybrid and the like); schemas 375; data relationships 376, including data dependencies; data size 377 and data complexity 378. In specific embodiment the assessment 330 serves to identify the difference(s)/gap(s) 340. In other instances, the difference(s)/gap(s) are identified by mapping the differences in structure, conventions (e.g., naming, formats) and data integrity rules.

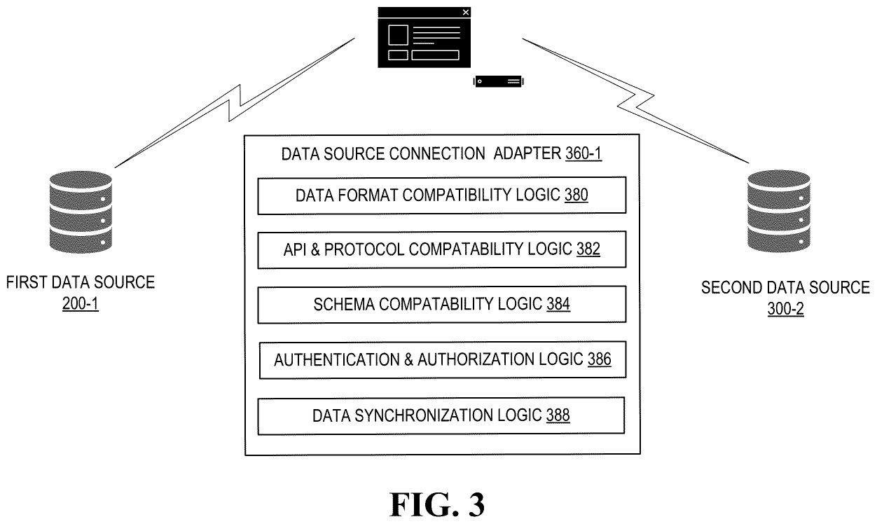

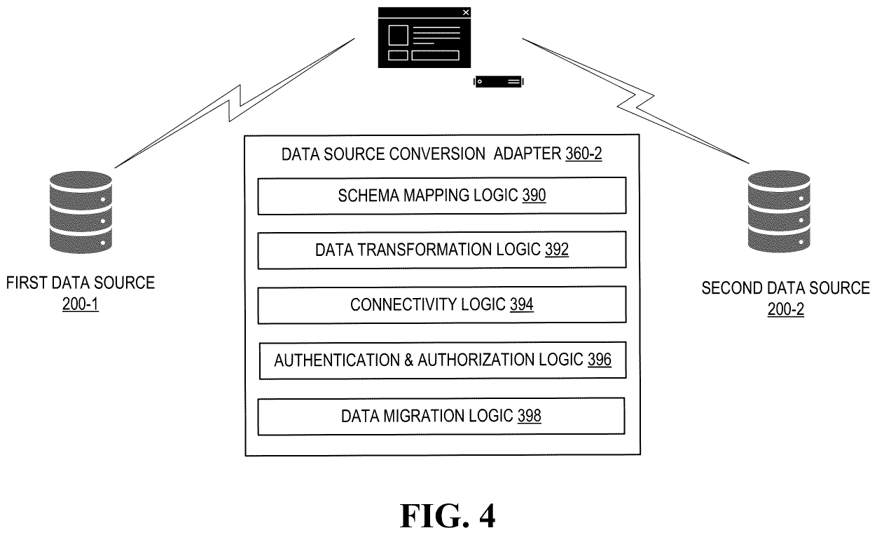

In response to identifying the differences 340, data integration engine 310 is further configured to implement at least one the GenAI model(s) 350 to generate an integration adapter 360 that is data source-specific and based at least on (i) assessment 330 of the first and second data sources 200-1, 200-2, and (ii) identified differences 340 between the first and second data sources 200-1, 200-2. In specific embodiments of the system 100, the integration adapter is a data source connection adapter 360-1 (discussed in more detail in relation to FIG. 3, infra.) or a data source conversion adapter 360-2 (discussed in more detail in relation to FIG. 4, infra.). The integration adapter 360 is configured to integrate (e.g., connect or convert) the first and second data sources 200-1, 200-2 by generating executable-code that addresses the identified differences between the first and second data sources 200-1, 200-2. In response to generating the integration adapter 360, data integration engine 300 is configured to execute the integration adapter 360 to integrate 362 the first and second data sources 200-1, 200-2.

Referring to FIG. 3, a schematic/block diagram is presented in which the integration adapter 360 takes the form of a data source connection adapter 360-1 configured to connect the first data source 200-1, in accordance with embodiments of the present invention.

In such embodiments of the invention, data source connection adapter 360-2 may include, but is not limited to, one or more logic 380, 382, 384, 386 and 388 depicted in FIG. 3. Data format compatibility logic 380 is configured to assure that data aligns in formats such as, but not limited to, CSV, JSON, XML or database schemas, such as, but not limited to, SQL. For unstructured data, logic 380 may include instructions for parsing text, images or other unstructured data. Moreover, data format compatibility logic 380 may include data type matching so that fields from each data source use compatible data types (e.g., integers, strings and the like). Application Programming Interface (API) and protocol compatibility logic 382 is configured to assure that exposed APIS are supported by compatible standards, such as, but not limited to, REST, SOAP, GraphQL and the like. Moreover, API and protocol compatibility logic ensures that connected data sources support a common protocol, such as, but not limited to, HTTP, FTP, or proprietary protocols, such as, but not limited to, ODBC, JDBC or the like. databases.

Schema compatibility logic 384 is applicable to structured data sources (e.g., databases and the like) and is configured to ensure that first and second data sources 200-1, 200-2 schemas align or, in the event that the schemas do not align, provide for a transformation/mapping layer. Moreover, in the event that the schemas evolve over time (i.e., new versions), the logic 384 is configured to ensure backward compatibility or versioning to avoid disruptions in connections. Authentication and authorization logic 386 is configured to ensure that both the first and second data sources 200-1, 200-2 include compatible methods for authentication, such as, but not limited to, API keys, OAuth, SSO or the like and that appropriate read/write permissions are granted for data to be shared between the first and second data sources 200-1, 200-2.

Data synchronization logic 388 is configured to ensure a match between real-time or batch synchronization mechanisms and that the source of data exchanges between the data sources can provide delta updates if needed (e.g., Change Data Capture or the like). Additional logic, not shown in FIG. 3, may be included in data connection adapter, such as software and driver compatibility logic, encoding and localization compatibility logic, scalability and performance logic and compliance, security compatibility logic and the like. In instances in which 380, 382, 384, 386 and 388 logic determines incompatible data format, API/protocol, schema, authentication/authorization and/or data synchronization, the logic is configured to perform necessary translations and/or transformations to intermediary or target data formats, APIs/protocols, schemas, authentications/authorizations and/or data synchronizations to allow for the flow of data between the connected first and second data sources 200-1, 200-2.

Referring to FIG. 4 a schematic/block diagram is presented in which the integration adapter 360 takes the form of a data source conversion adapter 360-2 configured to connect the first data source 200-1, in accordance with embodiments of the present invention.

In such embodiments of the invention, data source conversion adapter 360-2 may include, but is not limited to, one or more logic 390, 392, 394, 396 and 398 depicted in FIG. 4. Schema mapping logic 390 is applicable to structured data sources (e.g., databases and the like) and is configured to map, tables, fields and relationships between the two data sources and align data types, adjust schemas if one is normalized and a corresponding schema is denormalized and perform relationship conversion using foreign key relationships or hierarchical structures. Moreover, schema mapping logic may employ future know or known mapping tools, such as SQL Server Integration Service (SSIS), Talend, Pentaho or the like. Data transformation logic 392 is configured to perform ETL (Extract data from the source (e.g., first data source 200-1), Transform the data to match target schema (e.g., second data source 200-2) and Load the data in the target). Further, data transformation logic is configured to address differences in data formats, such as dates, units of measure, currencies, locales and the like. Moreover, data transformation logic 392 is configured to standardize null and predefined fallback values and remove duplicate data during the transformation.

Connectivity logic 394 is configured to install and configure appropriate drivers and, where needed to circumvent the failure to interoperate, employ middleware tools. Moreover, connectivity logic is configured to leverage APIs for complex or custom transformations when direct connections are unsupported. Authentication and authorization logic 396 is configured to ensure that both the first and second data sources 200-1, 200-2 include compatible methods for authentication, such as, but not limited to, API keys, OAuth, SSO or the like and that appropriate read/write permissions are granted for data to be shared between the first and second data sources 200-1, 200-2. Data migration logic 398 is configured to determine if migration is a one-time only event or incremental, and, where applicable, perform tests on a subset of the data to ensure correctness and performance before full migration. Additional logic, not shown in FIG. 4, may be included in data conversion adapter 360-2, such as performance tuning logic, testing and validation logic, documentation and monitoring logic and the like.

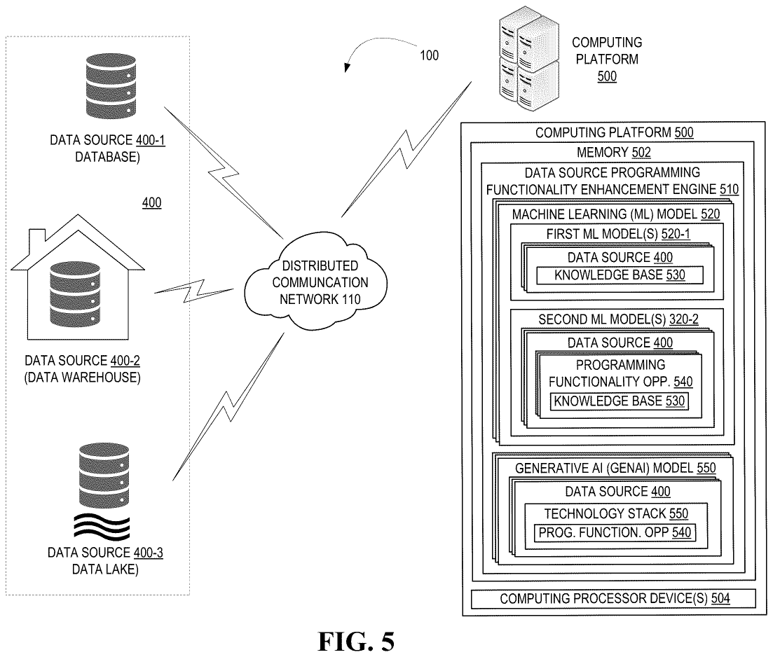

Referring to FIG. 5, a schematic/block is presented of a system 120 for data source programming functionality enhancement, in accordance with embodiments of the present invention. The system 120 is implemented amongst a distributed communication network 110, which may include the Internet, one or more intranets, cellular network(s) or the like. The system 120 includes a plurality of data sources 400; as shown in FIG. 5, data source 400-1, which is a database, data source 400-2, which is a data warehouse and data source 400-3, which is a data lake. One of ordinary skill in the art will appreciate that the data sources 400 may include other known or future known types of data sources.

System 100 additionally includes computing platform 500, which may comprise one or more servers or any other suitable computing device(s). Computing platform 500 includes memory 502 and one or more computing processor devices 304 in communication with memory 502. Memory 502 of computing platform 500 stores data source programming functionality enhancement engine 510, which includes Artificial Intelligence (AI), specifically one or more Machine Learning (ML) models 520 and Generative AI (GenAI) models 550. Data integration engine 310 is executable by at least one of the computing processor device(s) 304.

Data source programming functionality enhancement engine 510 is configured to implement at least one first ML model(s) 520-1 which have been trained to scan and analyze each data source 400 to determine a knowledge base 530 for the corresponding data source 400. In response to determining the knowledge base, data source programming functionality enhancement engine 510 is further configured to implement second ML model(s) 520-2 which have been trained to identify, based on the knowledge base 530, programming functionality opportunity(s) 540 for one or more of the data sources 400.

In response to identifying the programming functionality opportunity(s) 540, data source programming functionality enhancement engine 510 is further configured to implement at least one GenAI models 550 to generate a least a portion of a technology stack 550 for the one or more of the data sources 400. The technology stack 550 includes at least one programming functionality needed to realize at least one of the programming functionality opportunities 540.

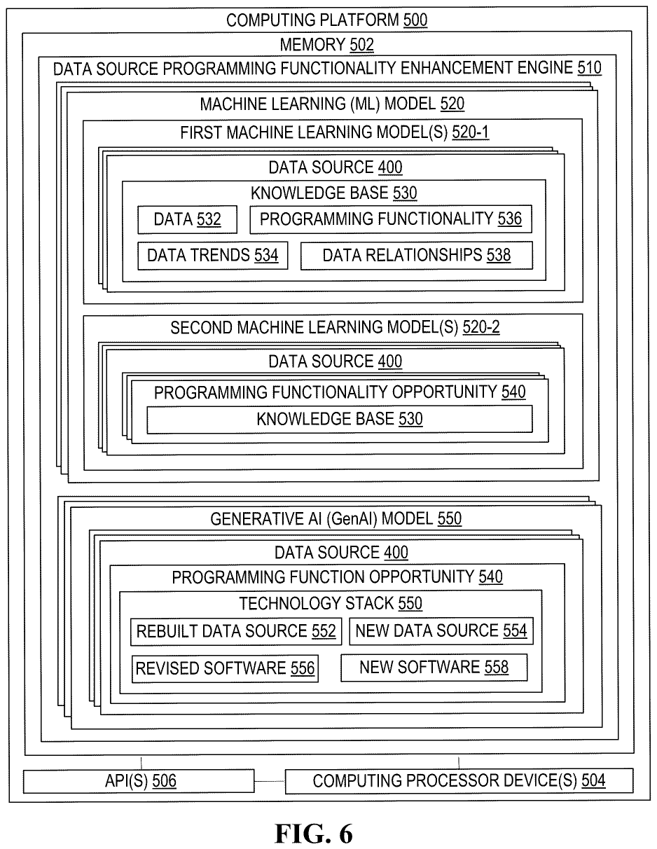

Referring to FIG. 6, a block diagram is depicted of computing platform 500 highlighting various alternate embodiments of the system 120 shown and described in relation to FIG. 5, in accordance with embodiments of the present invention. Computing platform 500 may comprise one or multiple computing devices, such servers or the like. As previously discussed in relation to FIG. 5, computing platform 500 includes memory 502, which may comprise volatile and/or non-volatile memory, such as read-only memory (ROM) and/or random-access memory (RAM), EPROM, EEPROM, or any memory common to computing platforms. Moreover, memory 502 may comprise cloud storage, such as provided by a cloud storage service and/or a cloud connection service.

Further, computing platform 500 includes one or more computing processor devices 304, which may be an application-specific integrated circuit (“ASIC”), or other chipset, logic circuit, or other data processing device. Computing processor device(s) 504 may execute one or more application programming adapter (APIs) 506 that adapter with any resident programs, such as data source programming functionality enhancement engine 510 or the like, stored in memory 502 of computing platform 500 and any external programs. Computing platform 500 includes various processing sub-systems (not shown in FIG. 2) embodied in hardware, firmware, software, and combinations thereof, that enable the functionality of computing platform 500 and the operability of computing platform 500 on a distributed communication network 110 (shown in FIG. 5). For example, processing sub-systems allow for initiating and maintaining communications and exchanging data with other networked devices. For the disclosed aspects, processing sub-systems of computing platform 500 includes any processing sub-system portion used in conjunction with data source programming functionality enhancement engine 510, tools, routines, sub-routines, applications, sub-applications, sub-modules thereof.

In specific embodiments of the present invention, computing platform 500 additionally includes a communications module (not shown in FIG. 6) embodied in hardware, firmware, software, and combinations thereof, that enables electronic communications between components of computing platform 500 and other networks and network devices, such data sources 200. Thus, communication module includes the requisite hardware, firmware, software and/or combinations thereof for establishing and maintaining a network communication connection with one or more devices and/or networks.

As previously discussed in relation to FIG. 5, memory 502 stores data source programming functionality enhancement engine 510, which is executable by at least one of the computing processor device(s) 504. Data source programming functionality enhancement engine 510, includes Artificial Intelligence (AI), which includes, but is not limited to Machine Learning model(s) 520 and Generative AI (GenAI) model(s) 550.

Data source programming functionality enhancement engine 510, is configured to implement one or more of the first ML model(s) 320-1 which have been trained to scan and analyze each data source 400 to determine a knowledge base 530 for the corresponding data source 400. The knowledge base 530 may comprise, but is not limited to, the data 532, data trends 534, current programming functionality 536 and data relationships 538 including data dependencies. Data trends 534 provides for the data to be tracked over time and, as such, the first ML model(s) 520-1 may be configured to continuously (e.g., on a scheduled basis or the like) be implemented on the data sources to be able to assess data trends 544.

In response to determining the knowledge base, data source programming functionality enhancement engine 510 is further configured to implement second ML model(s) 520-2 which have been trained to identify, based on the knowledge base 530, programming functionality opportunity(s) 540 for one or more of the data sources 400.

In response to identifying the programming functionality opportunity(s) 540, data source programming functionality enhancement engine 510 is further configured to implement at least one GenAI models 550 to generate a least a portion of a technology stack 550 for the one or more of the data sources 400. The technology stack 550 includes at least one programming functionality needed to realize at least one of the programming functionality opportunities 540. In specific embodiments of the invention generating the portion of the technology stack 550 includes one or more of (i) rebuilding 552 the data source, (ii) generating a new data source 554, (iii) revising 556 existing software including application-level software that uses the data source 400 and/or data source management software and/or (iv) generating new software 558 including application-level software that uses the data source 400 and/or data source management software.

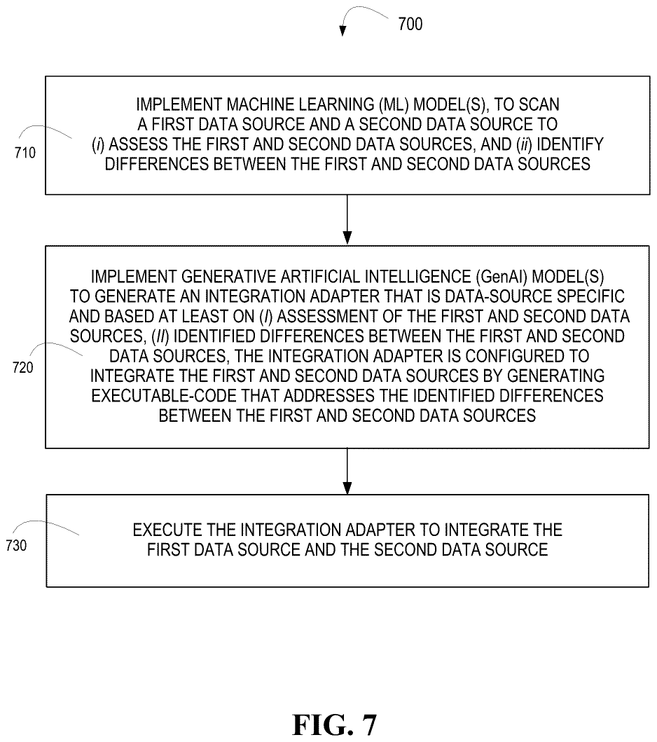

Referring to FIG. 7, a flow diagram is depicted of a method 700 for data source integration, in accordance with embodiments of the present invention. At Event 710, Machine Learning (ML) model(s) is/are implemented which have been trained to scan a data sources, specifically first and second data sources to (i) assess the data sources and (ii) identify differences/gaps in the data sources. As previously discussed, assessing the data sources may include, but is not limited to, assessing the data; the data source type (e.g., database, data repository, data ware house, data lake or the like); data source version; encoding used within the data source; storage mechanisms (e.g., SQL, NoSQL, relational, object-oriented, cloud, file systems, in-memory, stream, hybrid and the like); schemas; data relationships, including data dependencies; data size and data complexity. In specific embodiment the assessment serves to identify the difference(s)/gap(s). In other instances, the difference(s)/gap(s) are identified by mapping the differences in structure, conventions (e.g., naming, formats) and data integrity rules.

In response to identifying the difference(s)/gap(s), at Event 720, GenAI model(s) is/are implemented to generate an integration adapter that is data source-specific (e.g., specific to the first and second data sources) and based at least on (i) the assessment of the data sources and (ii) identified difference(s)/gap(s) in the data sources. The integration adapter includes executable code that, when executes, addresses the identified difference(s)/gap(s) in the data sources. In specific embodiments of the method, the integration adapter is a data source connection adapter configured to connect that first data source to the second data source. In such embodiments of the method, the data source connection adapter may include, but is not limited to, data format compatibility logic, API and protocol compatibility logic, schema compatibility logic, authentication/authorization logic, data synchronization logic and the like. In specific embodiments of the method, the integration adapter is a data source conversion adapter configured to convert that first data source to the second data source. In such embodiments of the method, the data source conversion adapter may include, but is not limited to, schema mapping logic, data transformation logic, connectivity logic, authentication/authorization logic, data migration logic and the like.

In response to generating the integration adapter, at Event 730, the integration adapter is executed to integrate (e.g., connect or convert) the first and second data sources.

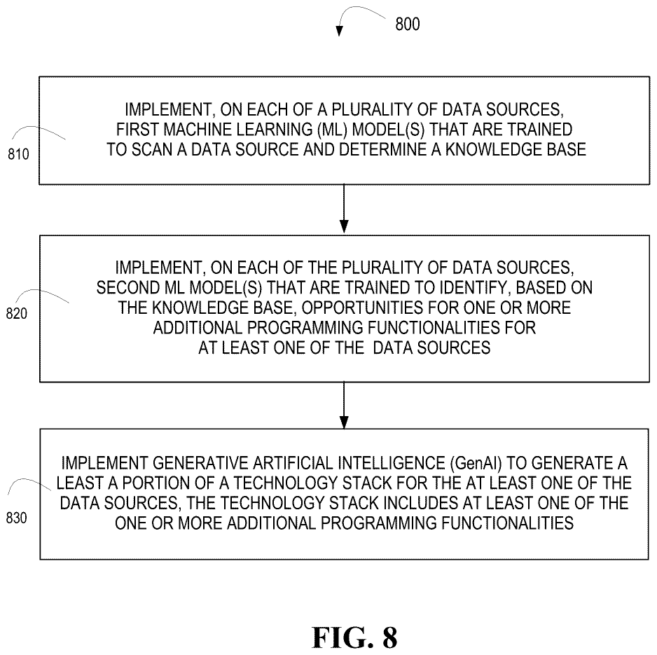

Referring to FIG. 8, a flow diagram is depicted of a method 800 for data source programming functionality enhancement, in accordance with embodiments of the present invention. At Event 810, one or more of the first ML model(s) is/are implement. The first ML model(s) have been trained to scan and analyze data sources to determine a knowledge base for the corresponding data source. The knowledge base may comprise, but is not limited to, the data in the data source, data trends, current programming functionality and data relationships including data dependencies. Data trends provides for the data to be tracked over time and, as such, the first ML model(s) may be configured to continuously (e.g., on a scheduled basis or the like) be implemented on the data sources to be able to assess data trends.

In response to determining the knowledge base, at Event 820, second ML model(s) is/are implemented. Second ML model(s) have been trained to identify, based on the knowledge base, programming functionality opportunity(s) for one or more of the data sources.

In response to identifying the programming functionality opportunity(s), at Event 730, GenAI model(s) is/are implemented to generate a least a portion of a technology stack for the one or more of the data sources. The technology stack includes at least one programming functionality needed to realize at least one of the programming functionality opportunities. In specific embodiments of the invention generating the portion of the technology stack includes one or more of (i) rebuilding the data source, (ii) generating a new data source, (iii) revising existing software including application-level software that uses the data source and/or data source management software and/or (iv) generating new software including application-level software that uses the data source and/or data source management software.

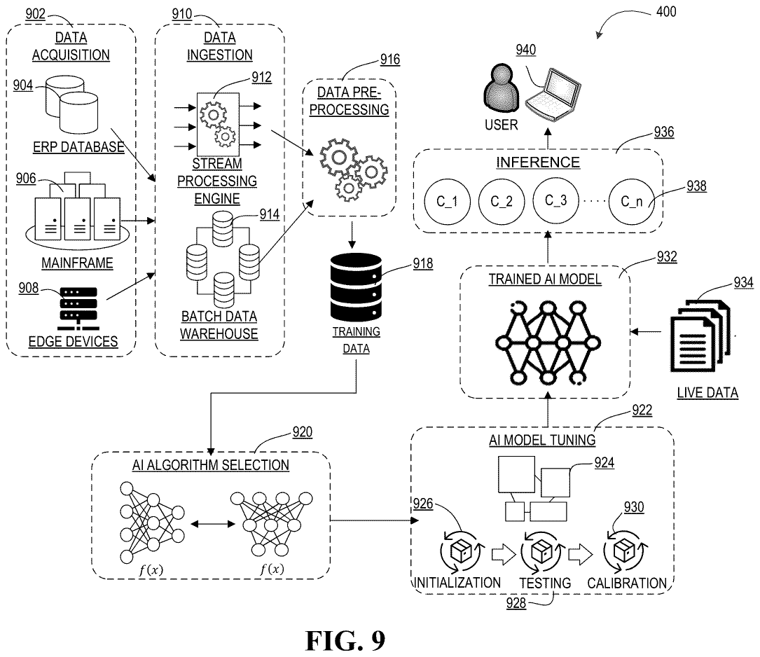

FIG. 9 illustrates an exemplary machine learning (ML) subsystem architecture 900, in accordance with an embodiment of the invention. The machine learning subsystem 900 may include a data acquisition engine 902, data ingestion engine 910, data pre-processing engine 916, ML model tuning engine 922, and inference engine 936.

The data acquisition engine 902 may identify various internal and/or external data sources to generate, test, and/or integrate new features for training the machine learning model 924. These internal and/or external data sources 904, 906, and 908 may be initial locations where the data originates or where physical information is first digitized. The data acquisition engine 902 may identify the location of the data and describe connection characteristics for access and retrieval of data. In some embodiments, data is transported from each data source 904, 906, or 908 using any applicable network protocols, such as the File Transfer Protocol (FTP), Hyper-Text Transfer Protocol (HTTP), or any of the myriad Application Programming Adapters (APIs) provided by websites, networked applications, and other services. In some embodiments, these data sources 904, 906, and 908 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 902 from these data sources 904, 906, and 908 may then be transported to the data ingestion engine 910 for further processing.

Depending on the nature of the data imported from the data acquisition engine 902, the data ingestion engine 910 may move the data to a destination for storage or further analysis. Typically, the data imported from the data acquisition engine 902 may be in varying formats as they come from diverse sources, including RDBMS, other types of databases, S3 buckets, CSVs, or from streams. Since the data comes from different places, it needs to be cleansed and transformed so that it can be analyzed together with data from other sources. At the data ingestion engine 902, the data may be ingested in real-time, using the stream processing engine 912, in batches using the batch data warehouse 914, or a combination of both. The stream processing engine 912 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 914 collects and transfers data in batches according to scheduled intervals, trigger events, or any other logical ordering.

In machine learning, the quality of data and the useful information that can be derived therefrom directly affects the ability of the machine learning model 924 to learn. The data pre-processing engine 916 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 916 may implement feature extraction and/or selection techniques to generate training data 918. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 918 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 922 may be used to train a machine learning model 924 using the training data 918 to make predictions or decisions without explicitly being programmed to do so. The machine learning model 924 represents what was learned by the selected machine learning algorithm 920 and represents the rules, numbers, and any other algorithm-specific data structures required for classification. Selecting the right machine learning algorithm may depend on a number of distinct factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 922 may repeatedly execute cycles of experimentation 926, testing 928, and tuning 930 to optimize the performance of the machine learning algorithm 920 and refine the results in preparation for deployment of those results for consumption or decision making. To this end, the ML model tuning engine 922 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 918. A fully trained machine learning model 932 is one whose hyperparameters are tuned and model accuracy maximized.

The trained machine learning model 932, similar to any other software application output, can be persisted to storage, file, memory, or application, or looped back into the processing component to be reprocessed. More often, the trained machine learning model 932 is deployed into an existing production environment to make practical business decisions based on live data 934. To this end, the machine learning subsystem 900 uses the inference engine 936 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 938) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 938) live data 934 based on how similar they are to one another to solve exploratory challenges where little is known about the data, provide a description or label (e.g., C_1, C_2 . . . .C_n 938) to live data 934, such as in classification, and/or the like. These categorized outputs, groups (clusters), or labels are then presented to the user input system 940. In still other cases, machine learning models that perform regression techniques may use live data 934 to predict or forecast continuous outcomes.

It will be understood that the embodiment of the machine learning subsystem 900 illustrated in FIG. 9 is exemplary and that other embodiments may vary. As another example, in some embodiments, the machine learning subsystem 300 may include more, fewer, or different components.

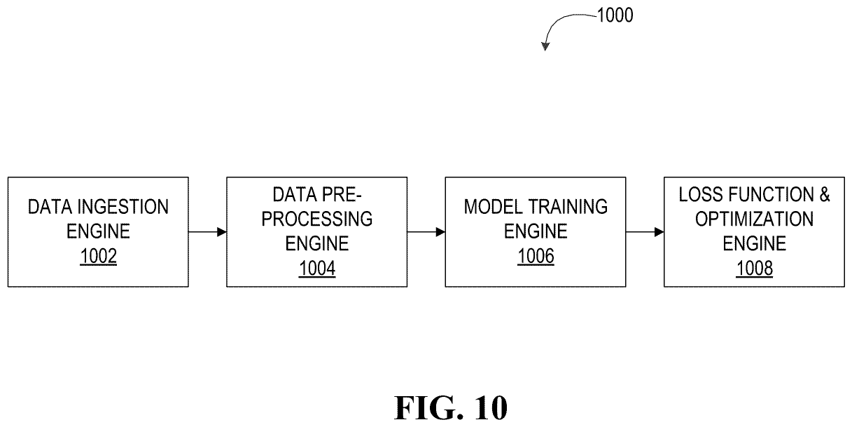

FIG. 10 illustrates an exemplary generative AI subsystem 1000, in accordance with an embodiment of the invention. The generative AI subsystem 1000 may include a data ingestion engine 1002, a data pre-processing engine 1004, and a model training engine 1006. It should be understood that the generative AI subsystem 1000 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 1000 should not be considered limiting and may be adapted to various configurations within the scope of the invention.

The data ingestion engine 1002 may identify various internal and/or external data sources to generate, test, and/or integrate new features for training the generative AI model. These internal and/or external data sources may be initial locations where the data originates or where physical information is first digitized. In addition to conventional data sources, the data ingestion engine 1002 may support decentralized storage systems, such as blockchain-based data sources, and privacy-preserving methods such as differential privacy. The data ingestion engine %02 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Adapters (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 1002 may move the data to a destination for storage or further analysis. Typically, the data may be in varying formats as they come from different sources, including RDBMS, other types of databases, S3 buckets, CSVs, or from streams. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In machine learning, the quality of data and the useful information that can be derived therefrom directly affects the ability of the machine learning model to learn. The data pre-processing engine 1004 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed. In some embodiments, the data pre-processing engine 1004 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 1004 may transform categorical data into numerical formats that are suitable for machine learning algorithms. In this regard, the data pre-processing engine 1004 may use techniques such as one-hot encoding or label encoding depending on the nature of the categorical variables and the intended use of the data.

In some embodiments, the data pre-processing engine 1004 may also include dimensionality reduction techniques, where the number of input features is reduced while retaining the most relevant information. In this regard, the data pre-processing engine 1004 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 1004 may then be fed into the model training module 1006.

The model training engine 1006 may be responsible for training the generative AI models using the pre-processed data from the data pre-processing engine 1004. The model training engine 1006 may implement various machine learning algorithms, including but not limited to Generative Adversarial Networks (GANs), Variational Autoencoders (VAEs), or other generative models, depending on the specific requirements of the system. The model training engine 1006 may optimize these models by continuously adjusting their internal parameters based on the patterns and relationships identified within the data.

In some embodiments, the model training engine 1006 may include a training data handler, which manages the partitioning of the pre-processed data into training, validation, and testing datasets. The training data is used to update the model's parameters, while the validation and testing datasets are reserved to evaluate the model's performance during and after training. The model training engine 1006 may support various data-handling strategies, such as cross-validation or random shuffling, to ensure that the model generalizes well and is not overfitting to the training data.

For VAEs, the model training engine 1006 may implement an encoder-decoder architecture. In this architecture, the encoder is responsible for compressing or mapping the input data into a lower-dimensional latent space representation, capturing the essential features of the input data while discarding unnecessary details. The decoder, in turn, reconstructs the input data from this latent representation, aiming to recreate the original data as closely as possible. During training, the VAE model seeks to minimize a loss function that typically consists of two components: reconstruction loss and Kullback-Leibler (KL) divergence loss.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 1006, which includes an optimization module 1008, may implement various optimization techniques to improve model performance and efficiency. The optimization module 1008 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 1008 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In embodiments using GANs, the model training engine 1006 may train two distinct but interconnected networks: the generator and the distinguisher. The generator network is responsible for generating synthetic data samples, typically starting from random noise vectors or points sampled from a latent space. The generator's objective is to learn how to map this random input into realistic data that closely resembles the actual data distribution from the training set, such as images, financial plans, or any other domain-specific data. On the other side, the distinguisher network is tasked with differentiating between the real data—coming directly from the training set—and the synthetic data generated by the generator. The distinguisher acts as a binary classifier, aiming to correctly classify whether the input data is real or fake. Its job is to improve its accuracy over time in detecting whether the data it is evaluating comes from the true data distribution or has been synthetically created by the generator.

The training process of a GAN is adversarial in nature, where the two networks engage in a zero-sum contest. The generator continuously tries to improve its ability to generate convincing data, while the distinguisher simultaneously improves its capacity to distinguish between real and generated data. During each training iteration, the generator attempts to “fool” the distinguisher by creating more realistic data samples, while the distinguisher receives feedback to better catch fake data. This adversarial feedback loop leads both networks to improve their performance over time. The loss functions for both networks guide this competition: the generator's loss reflects how well it was able to fool the distinguisher, while the distinguisher's loss reflects how accurately it classified real versus generated data. Through this iterative, competitive process, the generator becomes increasingly skilled at producing highly realistic data samples that are difficult for the distinguisher to differentiate from real data. Eventually, the generator learns to generate synthetic data that is nearly indistinguishable from the real data.

The loss function & optimization engine 1008 includes a parameter optimization module, which may optimize the model's parameters using gradient-based optimization techniques such as stochastic gradient descent (SGD), Adam, or other suitable algorithms. The optimization process may minimize the loss function calculated during each training iteration (or epoch), adjusting the weights and biases of the model to improve its ability to learn from the data. The parameter optimization module may also dynamically adjust learning rates, momentum, and other hyperparameters to further enhance training efficiency.

In some embodiments, the model training engine 1006 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 1006 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 1006 may synchronize the updates across the nodes using techniques like synchronous or asynchronous gradient descent.

Once the generative AI model is trained, the model training engine 1006 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 1006 may also implement transfer learning, where a pre-trained model is fine-tuned on a smaller, domain-specific dataset. This may reduce the amount of time and data required to train a new model, especially in cases where the available data is limited or highly specialized. The model training engine 1006 may adjust the parameters of the pre-trained model to better align with the new dataset, while preserving the learned features from the original training.

In embodiments where a VAE is used to train the generative AI model, generating new output involves providing an input to the trained model in the form of a point or distribution in the latent space. During training, the encoder network learned to compress input data into this latent space, while the decoder learned to map points from the latent space back into meaningful data. To generate new data, the system may sample a point from the latent space, typically by sampling from a predefined distribution (e.g., a Gaussian distribution), or a user may provide specific coordinates within the latent space to control the nature of the output. The decoder network then transforms this latent vector into a new data instance (e.g., an image or piece of text) that conforms to the patterns learned during training. Since the latent space has been structured to capture the key features of the input data, small variations in the latent space coordinates may result in new data with slight variations, allowing the system to produce diverse but coherent outputs.

In embodiments where the generative AI model has been trained using a GAN, the process for generating new output also involves providing an input in the form of a random noise vector sampled from the latent space. Unlike VAEs, where the latent space is learned explicitly during training, GANs use this latent space as a starting point for the generator to produce new data. The trained generator network takes the random input vector and transforms it into a new data sample, such as an image, based on the patterns it has learned during training. The distinguisher is no longer needed in this phase, as its role was limited to training. Once the generator has been trained to produce realistic outputs, it can generate new data by mapping random noise vectors to complex data points that resemble the original dataset. For example, in a GAN trained on images of landscapes, providing a random vector in the latent space will result in the generation of a new, never-before-seen landscape that adheres to the patterns the generator learned during training. The latent space in GANs encodes abstract features of the data, and small adjustments to the noise vector allow users to control specific aspects of the generated data, such as color, shape, or texture, enabling the generation of highly varied outputs.

It will be understood that the embodiment of the generative AI subsystem 1000 illustrated in FIG. 10 is exemplary and that other embodiments may vary. The generative AI subsystem 1000, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

Thus, as described in detail above, present embodiments of the invention include systems, methods, computer program products and/or the like that provide for implementing Artificial Intelligence (AI) to integrate disparate data sources. Specifically, Machine Learning (ML) is used to analyze disparate data sources to determine differences between the data sources and subsequently Generative Artificial Intelligence (GenAI) is used to generate an integration adapter that is data source-specific, acts as an intermediary for integrating (e.g., connecting or converting) the data sources and serves to address the determined differences/gaps between the data sources.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for data integration between two disparate data sources, the system comprising:
a first data source configured to store first data;
a second data source configured to store second data, wherein the second data source is disparate from the first data source; and
a computing platform including a memory and one or more computing processor devices in communication with the memory, wherein the memory stores a data integration engine including one or more Machine Learning (ML) models and one or more Generative Artificial Intelligence (GenAI) models, wherein the data integration engine is executable by at least one of the one or more computing processor devices and configured to:
implement at least one of the one or more ML models, to scan the first and second data sources to (i) assess the first and second data sources, (ii) identify differences between the first and second data sources,
implement at least one of the one or more GenAI models to generate an integration adapter that is data source-specific and based at least on (i) assessment of the first and second data sources, and (ii) identified differences between the first and second data sources, wherein the integration adapter is configured to integrate the first and second data sources by generating executable-code that addresses the identified differences between the first and second data sources, and
execute the integration adapter to integrate the first data source and the second data source.

2. The system of claim 1, wherein the first data source is chosen from a group consisting of a database, a data repository, a data warehouse, and a data lake, and wherein the second data source is chosen from a group consisting of a database, a data repository, a data warehouse, and a data lake.

3. The system of claim 1, wherein the data integration engine is further configured to:
implement the at least one of the one or more ML models, to scan the first and second data sources to assess the first and second data sources, wherein assessing the first and second data sources includes determining (i) data source type, (ii) version, (iii) encoding, (iv) storage mechanisms, (v) one or more schemas, (vi) data relationships, (vii) data size, and (viii) data complexity.

4. The system of claim 1, wherein the data integration engine is further configured to:
implement the at least one of the one or more GenAI models to generate the integration adapter, wherein the integration adapter is a data source conversion adapter configured to convert the first data source to the second data source.

5. The system of claim 4, wherein the data integration engine is further configured to:
implement the at least one of the one or more GenAI models to generate the data source conversion adapter, wherein the data source-specific conversation adapter includes schema mapping logic configured to perform data field matching, schema normalization, relationship conversion.

6. The system of claim 4, wherein the data integration engine is further configured to:
implement the at least one of the one or more GenAI models to generate the data source conversion adapter, wherein the data source-specific conversation adapter includes data transformation logic configured to extract the data from the first data source, transform the data to match a schema of the second data source and load the transformed data into the second data source, wherein transforming the data includes addressing null and predefined fallback values and removing duplicate data.

7. The system of claim 4, wherein the data integration engine is further configured to:
implement the at least one of the one or more GenAI models to generate the data source conversion adapter, wherein the data source-specific conversation adapter includes connectivity logic configured to install requisite drivers and generate Application Programming Adapters (APIs).

8. The system of claim 4, wherein the data integration engine is further configured to:
implement the at least one of the one or more GenAI models to generate the data source conversion adapter, wherein the conversation adapter includes data migration logic configured to orchestrate the migration of data from the first data source to the second data source.

9. The system of claim 1, wherein the data integration engine is further configured to:
implement the at least one of the one or more GenAI models to generate the integration adapter, wherein the integration adapter is a data source connection adapter configured to connect the first data source to the second data source.

10. The system of claim 9, wherein the data integration engine is further configured to:
implement the at least one of the one or more GenAI models to generate the data source connection adapter, wherein the data source connection adapter includes data format compatibility logic configured to align structured formats and schemas and parse unstructured data.

11. The system of claim 9, wherein the data integration engine is further configured to:
implement the at least one of the one or more GenAI models to generate the data source connection adapter, wherein the data source connection adapter includes Application Programming Adapter (API) and protocol compatibility logic configured to assure API and protocol compatibility between the first and second data sources.

12. The system of claim 9, wherein the data integration engine is further configured to:
implement the at least one of the one or more GenAI models to generate the data source connection adapter, wherein the data source connection adapter includes schema compatibility logic configured to align schemas from the first data source and the second data source and, in stances where alignment is not feasible, map and transform schemas.

13. The system of claim 9, wherein the data integration engine is further configured to:
implement the at least one of the one or more GenAI models to generate the data source connection adapter, wherein the data source connection adapter includes authentication and authorization logic configured to exchange at least one of authentication credentials and authorization credentials between the first and second data sources.

14. The system of claim 9, wherein the data integration engine is further configured to:
implement the at least one of the one or more GenAI models to generate the data source connection adapter, wherein the data source connection adapter includes data synchronization logic configured to assure real-time or batch synchronization mechanisms are equivalent.

15. A computer-implemented method for data integration between two disparate data sources, the computer-implemented method is executed by one or more computing processor devices and comprises:
implementing at least one Machine learning (ML) model, to scan a first data source and a second data source to (i) assess the first and second data sources, and (ii) identify differences between the first and second data sources;
implementing at least one Generative Artificial Intelligence (GenAI) model to generate an integration adapter that is data-source specific and based at least on (i) assessment of the first and second data sources, (ii) identified differences between the first and second data sources, wherein the integration adapter is configured to integrate the first and second data sources by generating executable-code that addresses the identified differences between the first and second data sources; and
executing the integration adapter to integrate the first data source and the second data source.

16. The computer-implemented method of claim 15, wherein implementing the at least one ML model further comprises:
implementing the at least one ML models, to scan the first and second data sources to assess the first and second data sources, wherein assessing the first and second data sources includes determining (i) data source type, (ii) version, (iii) encoding, (iv) storage mechanisms, (v) one or more schemas, (vi) data relationships, (vii) data size, and (viii) data complexity.

17. The computer-implemented method of claim 15, wherein implementing the at least one GenAI model further comprises:
implementing the at least one GenAI model to generate the integration adapter, wherein the integration adapter is a data source conversion adapter configured to convert the first data source to the second data source and includes (i) schema mapping logic configured to perform data field matching, schema normalization, relationship conversion, (ii) data transformation logic configured to extract the data from the first data source, transform the data to match a schema of the second data source and load the transformed data into the second data source, wherein transforming the data includes addressing null and predefined fallback values and removing duplicate data, (iii) connectivity logic configured to install requisite drivers and generate Application Programming Adapters (APIs) and (iv) data migration logic configured to orchestrate the migration of data from the first data source to the second data source.

18. The computer-implemented method of claim 15, wherein implementing the at least one GenAI model further comprises:
implementing the at least one GenAI model to generate the integration adapter, wherein the integration adapter is a data source connection adapter configured to connect the first data source to the second data source and includes (i) data format compatibility logic configured to align structured formats and schemas and parse unstructured data, (ii) Application Programming Adapter (API) and protocol compatibility logic configured to assure API and protocol compatibility between the first and second data sources, (iii) schema compatibility logic configured to align schemas from the first data source and the second data source and, in stances where alignment is not feasible, map and transform schemas, (iv) authentication and authorization logic configured to exchange at least one of authentication credentials and authorization credentials between the first and second data sources and (v) data synchronization logic configured to assure real-time or batch synchronization mechanisms are equivalent.

19. A computer program product including a non-transitory computer-readable medium, the non-transitory computer-readable medium comprising sets of codes for causing one or more computing devices to:
implement at least one Machine learning (ML) model, to scan a first data source and a second data source to (i) assess the first and second data sources, and (ii) identify differences between the first and second data sources;
implement at least one Generative Artificial Intelligence (GenAI) model to generate a integration adapter that is data-source specific and based at least on (i) assessment of the first and second data sources, (ii) identified differences between the first and second data sources, wherein the integration adapter is configured to integrate the first and second data sources by generating executable-code that addresses the identified differences between the first and second data sources; and
execute the integration adapter to integrate the first data source and the second data source.

20. The computer program product of claim 19, wherein the set of codes for causing the one or more computing devices to implement the at least GenAI models are further configured to cause the one or more computing devices to:
implement the at least one GenAI model to generate the integration adapter, wherein the integration adapter is chosen from a group consisting of a data source connection adapter and a data source conversion adapter.
